(19) United States
(12) Patent Application Publication
(10) Pub. No.: US 2013/0287187 A1
(43) Pub. Date: Oct. 31, 2013

(54) CONVEYING CONTEXT-SENSITIVE INFORMATION FOR A CONVERSATION

(71) Applicants: Ankur Gandhe, Bangalore (IN); Nandakishore Kambhatla, Bangalore (IN); Amit Kumar Singh, Mumbai (IN); Karthik Visweswariah, Bangalore (IN)

(72) Inventors: Ankur Gandhe, Bangalore (IN); Nandakishore Kambhatla, Bangalore (IN); Amit Kumar Singh, Mumbai (IN); Karthik Visweswariah, Bangalore (IN)

(73) Assignee: INTERNATIONAL BUSINESS MACHINES CORPORATION, Amonk, NY (US)

(21) Appl. No.: 13/460,348

(22) Filed: Apr. 30, 2012

(51) Int. Cl. H04M 11/06

(52) U.S. Cl. 379/93.17

(57) ABSTRACT

Methods and arrangements for conveying context-sensitive information for a conversation. A topic of a conversation among at least one conversation participant is ascertained. Information related to the ascertained topic of conversation is obtained, and the obtained information is displayed to at least one conversation participant during the conversation.

### BACKGROUND

Generally, and in conventional settings, in a conversation or interaction that involves voice, text and/or video (the term “conversation” herein can be taken to encompass a conversation or interaction that involves voice, text and/or video), data and information can be exchanged at the touch of a button. Information about another party in the conversation can be displayed, though the information is not context-sensitive. Based on preset parameters, information from different databases can be merged and displayed on the basis of preset parameters. However, conventional arrangements are severely limited in the types of information that can be assimilated and displayed, and no allowance is afforded for context.

### BRIEF SUMMARY

In summary, one aspect of the invention provides a method comprising: automatically ascertaining a topic of a conversation involving at least one conversation participant; obtaining information related to the ascertained topic of conversation; and displaying the obtained information to at least one conversation participant during the conversation.

Another aspect of the invention provides an apparatus comprising: at least one processor; and a computer readable storage medium having computer readable program code embodied therewith and executable by the at least one processor, the computer readable program code comprising: computer readable program code configured to automatically ascertain a topic of a conversation involving at least one conversation participant; computer readable program code configured to obtain information related to the ascertained topic of conversation; and computer readable program code configured to display the obtained information to at least one conversation participant during the conversation.

An additional aspect of the invention provides a computer program product comprising: a computer readable storage medium having computer readable program code embodied therewith, the computer readable program code comprising: computer readable program code configured to automatically ascertain a topic of a conversation involving at least one conversation participant; computer readable program code configured to obtain information related to the ascertained topic of conversation; and computer readable program code configured to display the obtained information to at least one conversation participant during the conversation.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a system for providing context-sensitive information.

FIG. 2 schematically sets forth a flow of a sample assisted conversation.

FIG. 3 sets forth a process more generally for conveying context-sensitive information for a conversation.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

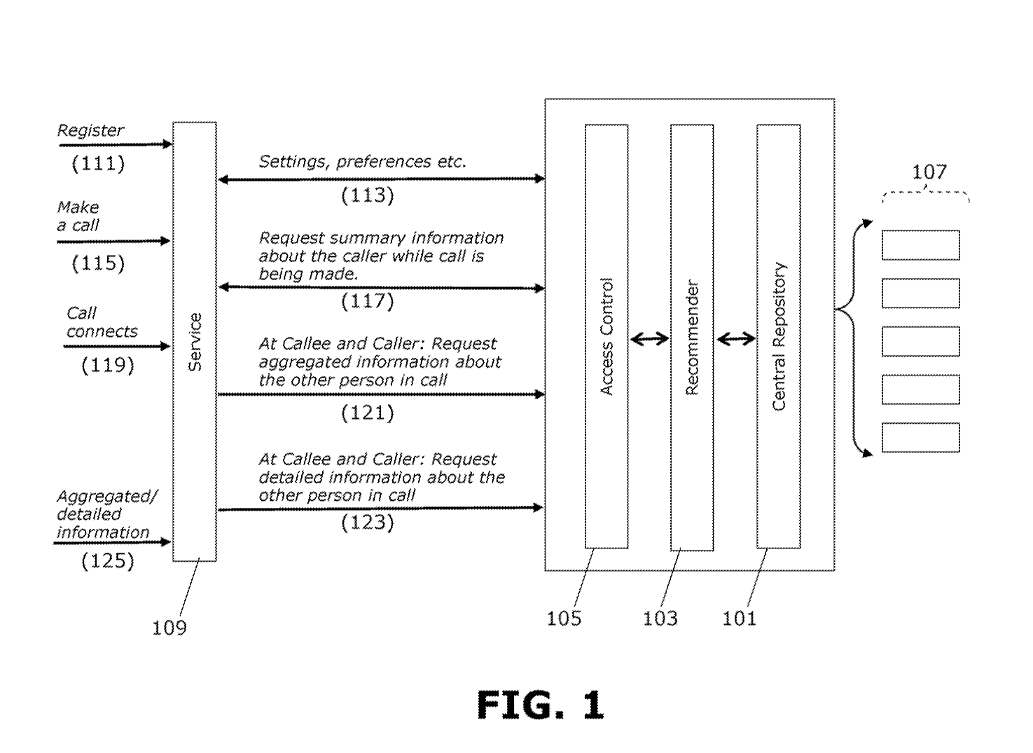

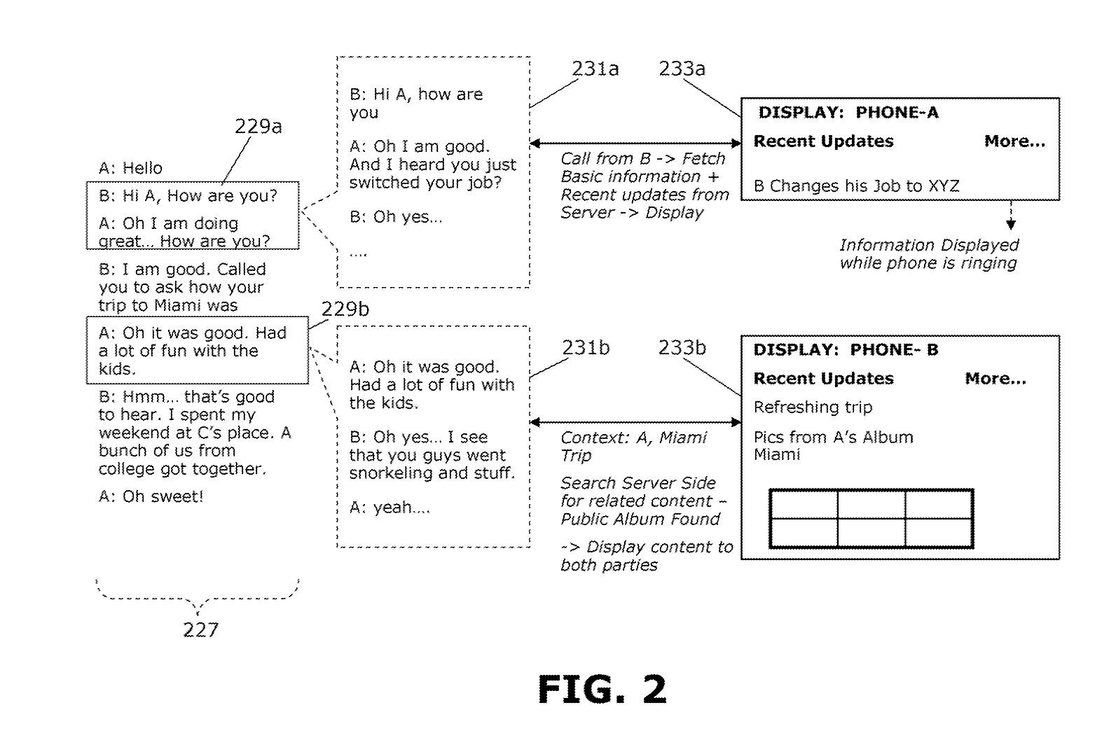

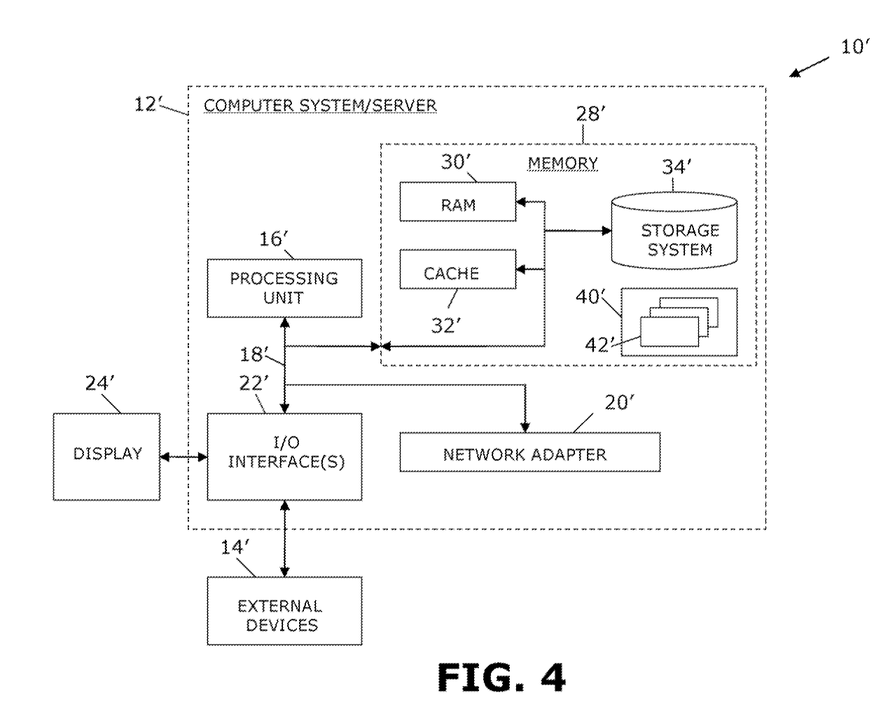

Specific reference will now be made herebelow to FIGS. 1 and 2. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1 and 2 can be performed or utilized by way of a processing unit or units and system memory such as those indicated, respectively, at 16′ and 28′ in FIG. 4, whether on a server computer, a client computer, a node computer in a distributed network, or any combination thereof.

In accordance with at least one embodiment of the invention, there is broadly contemplated herein a system for the facilitated accessibility (e.g., the display and/or sharing) of context specific content during a conversation. Context is obtained from the parties involved (e.g., via automatic speech recognition [ASR] and/or user input), content can be gathered from the internet (e.g., from a social network) or local device (e.g., email, calendar, photos), and content can be ranked according to given features (e.g., popularity, time, etc.) and context.

FIG. 1 schematically illustrates a system for providing context-sensitive information, in accordance with at least one embodiment of the invention. A central database (repository) 101 of entities' attributes and relations, includes content from information and data sources as well as links thereto. A content recommender 103 selects content during a conversation, while an access control module 105 handles content display and access rights.

By way of content processing and recommendation, in accordance with at least one embodiment of the invention, the potential importance of information is determined by a mining of social activity from information and data sources 107, which can include various social media or other sources. The central database 101 contains a social graph indicating entities (e.g., users) and their relations (e.g., friends of users in a social network), and recent updates and posts by entities. The central database 101 also indexes contacts, albums, e-mail and other device content. Context is determined via keyword ASR (for audio-based conversations) or extraction (for chat or email). Content can be recommended, via recommender 103, on the basis of a very wide variety of factors which can include, but are not limited to: profile updates (e.g., marital or relationship status, location, work information); categories (e.g., product reviews, movies, travel, etc.); “hot topics” based, e.g., on popularity, importance or mutual interests; a time of posting; who made a posting (e.g., self, other, mutual friend); and current context of a call. A recommendation engine algorithm can be employed here; by way of example, dynamic co-clustering can be undertaken wherein constraints are linked between two entities in a conversation. Generally, essentially any suitable algorithm can be employed where a current context of a conversation is automatically detected and used, and then combined with information from both the callee and caller to display appropriate information in real time on displays (e.g., on a smart phone or laptop) associated with the callee and caller, respectively.

In accordance with at least one embodiment of the invention, context-aware recommendation involves a monitoring of topics of current discussion and a recommendation of useful information for the conversation. For instance, matching keywords can be ascertained (e.g., noun phrases and names) in the social activity of a conversation participant, of mutual friends of the participants and in indexed contents in a device (e.g., a mobile phone), such as contacts, photographs and emails. The popularity of news around the topic of discussion in a conversation can also be ascertained, wherein popularity is ranked, e.g., by source, number of views, comments, replies, etc.

Generally, a process flow of registration and context conveyance, in accordance with at least one embodiment of the invention, can be handled through a service 109, such as a mobile operator or other service provider (wherein both the caller and callee parties are registered with the service and have accorded to the service suitable permissions to permit the display of contextual information contemplated herein). First, one or more customers can register (111) for the context conveyance service, at which point settings and preferences can be set (113). By way of illustrative example, such settings and preferences could include the types of sources that can be used for fetching information about oneself (e.g., social media sources), and access levels or privileges regarding with whom certain types of information can be shared. Access can be governed at an individual/group level and/or at a content level. For instance, it might be stipulated that only family members would be permitted to view personal information from social media sources. Other settings and preferences can include: enablement/disablement of recommendations; and sensing of context automatically or on invocation only.

In accordance with at least one embodiment of the invention, when a customer makes a call (115), then, summary information about the caller can be requested (117) when the call is in being made (or even after the connection has been established). Summary information can relate to updated and/or additional information that can be brought forward in general and/or added to repository 101, whether obtained automatically or via direct customer input. By way of example, summary information could represent a summary of recent important activities, a relationship status, and other personal information, any or all of which could be obtained from a social media site. The type of summary information so utilized can also be customized or preset via settings and preferences established in step (113).

In accordance with at least one embodiment of the invention, when a call connects (119), either the callee or caller can request aggregated information about the other person in the call (121), or detailed information (123). The aggregated/detailed information about either participant may then be provided to either participant (125). (Here, “aggregated” and “detailed” information need not necessarily be fundamentally different, other than that “aggregated” information is organized with respect to possible aspects, parameters or filters such as topics, subjects, sources, people, groups, etc.) The aggregated and detailed information (from steps 121 and 123) can derive from the repository 101 and recommender 103, and particularly can represent initial information that is recommended via algorithm (at recommender 103) from the repository 101 when at first no context has been established (e.g., just when the call connects at 119). This aggregated or detailed information can include information of mutual interest to both parties, as well as updates about the other party in the call and/or about mutual social or business acquaintances.

In accordance with at least one embodiment of the invention, while the process flow (steps 111-125) is discussed herein with respect to a phone call, it should be understood that such a process flow can also be applicable to other types of conversation as contemplated herein, such as essentially any conversation or interaction that involves voice, text or video.

In accordance with at least one embodiment of the invention, it should be appreciated and understood that context can be displayed via essentially any suitable medium, such as a display screen of a smart phone, laptop or desktop. Earphones or a headset could then allow a caller to participate in a call in an auditory manner while viewing contextual content on the screen. Other types of interaction may also take place during a conversation, e.g., a participant can undertake his/her own search while the conversation is taking place in order to derive additional information regarding a contextual topic that is being displayed.

FIG. 2 schematically sets forth a flow of a sample assisted conversation, in accordance with at least one embodiment of the invention. As shown, an unassisted conversation is indicated at 227 between callers A and B. Boxed text, at 229a and 229b in conversation 227, corresponds to potential introduction points of context-sensitive information. Thus, in accordance with the present example, indicated at 231a is a possible exchange between A and B if context-sensitive information is introduced, essentially replacing a shortened exchange as might otherwise take place (unassisted) as in box 229a. Here, when B completes a call to A, there comes to be displayed on A's phone (at 233a) some recent information on a job change for B. (This information can correspond to summary information as indicated at 117 in FIG. 1, in that information is already displayed [233a] at A's phone while the phone is still ringing and thus before the call connects.)

In accordance with the present example, in accordance with at least one embodiment of the invention, later in the conversation, indicated at 231b is another possible exchange between A and B with the introduction of more context-sensitive information, essentially replacing a shortened exchange as might otherwise take place (unassisted) as in box 229b. Here, B's utterance of “Miami” prompts the retrieval of public social site content at A's side, e.g., photographs from a trip to Miami, and the content comes to be displayed on B's phone (at 233b). (This information can correspond to aggregated/detailed information as indicated at 125 in FIG. 1, in that it comes up as a result of context detected in the conversation and thus is not displayed pre-emptively as a matter of course.)

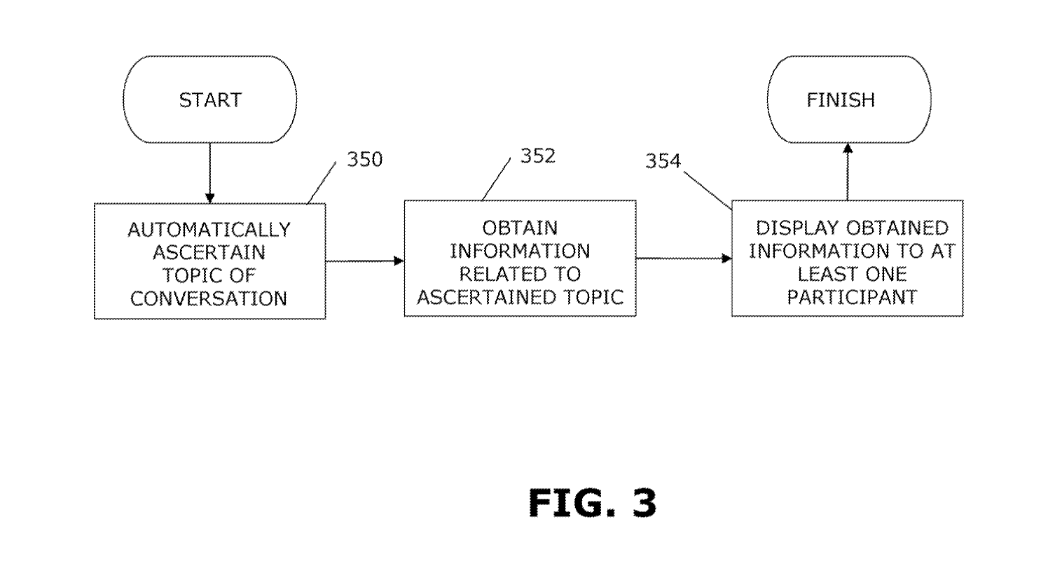

FIG. 3 sets forth a process more generally for conveying context-sensitive information for a conversation, in accordance with at least one embodiment of the invention. It should be appreciated that a process such as that broadly illustrated in FIG. 3 can be carried out on essentially any suitable computer system or set of computer systems, which may, by way of an illustrative and non-restrictive example, include a system such as that indicated at 12′ in FIG. 4. In accordance with an example embodiment, most if not all of the process steps discussed with respect to FIG. 3 can be performed by way a processing unit or units and system memory such as those indicated, respectively, at 16′ and 28′ in FIG. 4.

As shown in FIG. 3, a topic of a conversation involving at least one conversation participant is ascertained (350). Information related to the ascertained topic of conversation is obtained (352), and the obtained information is displayed to at least one conversation participant during the conversation (354).

Referring now to FIG. 4, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples, include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use b, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium (an article of manufacture) implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
automatically ascertaining a topic of a conversation involving at least one conversation participant;
obtaining information related to the ascertained topic of conversation; and
displaying the obtained information to at least one conversation participant during the conversation.

2. The method according to claim 1, wherein the conversation comprises at least one interaction selected from the group consisting of: voice interaction; text interaction;
and video interaction.

3. The method according to claim 1, comprising:
populating an information database with a corpus of content for display in conversations; and
said obtaining comprising obtaining information from the information database.

4. The method according to claim 1, wherein the at least one conversation participant comprises at least two conversation participants.

5. The method according to claim 1, comprising pre-registering at least one conversation participant.

6. The method according to claim 5, wherein said pre-registering comprises accepting input from at least one conversation participant on settings and preferences.

7. The method according to claim 6, wherein the settings and preferences comprise at least one member selected from the group consisting of: an access control setting; a source of information; parameter enablement; a setting for automatic context sensing; a setting for manually invoking context sensing; and a setting relating to summary information about a conversation participant.

8. The method according to claim 6, comprising:
obtaining and displaying information relating to at least one conversation participant prior to said step of automatically ascertaining a topic of conversation; and
the settings and preferences comprising a setting governing the display of information relating to at least one conversation participant prior to said step of automatically ascertaining a topic of conversation.

9. The method according to claim 1, wherein the obtained information comprises at least one member selected from the group consisting of: summary information about a conversation participant; detailed information about a conversation participant; and aggregated information about a conversation participant.

10. The method according to claim 1, comprising obtaining and displaying information relating to at least one conversation participant prior to said step of automatically ascertaining a topic of conversation.

11. The method according to claim 1, wherein the obtained information derives from at least one social media source.

12. An apparatus comprising:
at least one processor; and
a computer readable storage medium having computer readable program code embodied therewith and executable by the at least one processor, the computer readable program code comprising:
computer readable program code configured to automatically ascertain a topic of a conversation involving at least one conversation participant;
computer readable program code configured to obtain information related to the ascertained topic of conversation; and
computer readable program code configured to display the obtained information to at least one conversation participant during the conversation.

13. The apparatus according to claim 12, wherein the conversation comprises at least one interaction selected from the group consisting of: voice interaction; text interaction; and video interaction.

14. The apparatus according to claim 12, wherein the obtained information derives from at least one social media source.

15. A computer program product comprising:
a computer readable storage medium having computer readable program code embodied therewith, the computer readable program code comprising:
computer readable program code configured to automatically ascertain a topic of a conversation involving at least one conversation participant;
computer readable program code configured to obtain information related to the ascertained topic of conversation; and
computer readable program code configured to display the obtained information to at least one conversation participant during the conversation.

16. The computer program product according to claim 15, wherein the conversation comprises at least one interaction selected from the group consisting of: voice interaction; text interaction; and video interaction.

17. The computer program product according to claim 15, wherein said computer readable program code is configured to:
populate an information database with a corpus of content for display in conversations; and
obtain information from the information database.

18. The computer program product according to claim 15, wherein the at least one conversation participant comprises at least two conversation participants.

19. The computer program product according to claim 15, wherein said computer readable program code is configured to pre-register at least one conversation participant.

20. The computer program product according to claim 19, wherein said computer readable program code is configured to accept input from at least one conversation participant on settings and preferences.

21. The computer program product according to claim 20, wherein the settings and preferences comprise at least one member selected from the group consisting of: an access control setting; a source of information; parameter enablement; a setting for automatic context sensing; a setting for manually invoking context sensing; and a setting relating to summary information about a conversation participant.

22. The computer program product according to claim 20, wherein said computer readable program code is configured to:
obtain and display information relating to at least one conversation participant prior to said step of automatically ascertaining a topic of conversation; and
the settings and preferences comprising a setting governing the display of information relating to at least one conversation participant prior to said step of automatically ascertaining a topic of conversation.

23. The computer program product according to claim 15, wherein the obtained information comprises at least one member selected from the group consisting of: summary information about a conversation participant; detailed information about a conversation participant; and aggregated information about a conversation participant.

24. The computer program product according to claim 15, wherein said computer readable program code is configured to obtain and display information relating to at least one conversation participant prior to said step of automatically ascertaining a topic of conversation.

25. The computer program product according to claim 15, wherein the obtained information derives from at least one social media source.
